(19) United States
(12) Patent Application Publication
(10) Pub. No.: US 2009/0094121 A1
(43) Pub. Date: Apr. 9, 2009

(54) SYSTEM AND METHOD FOR ENABLING SELECTIVE CUSTOMER PARTICIPATION IN DYNAMICALLY CONFIGURING AND MANAGING AT LEAST A PORTION OF CUSTOMIZABLE INDIVIDUALIZED VICTUALS PROVISION SERVICES PROVIDED THERETO

(75) Inventors: Mark Newhouse, New York, NY (US); Bryan Janeczko, New York, NY (US)

Correspondence Address: EDWARD ETKIN, ESQ., Law Office of Edward Etkin, PC, 228 West End Avenue, Suite A, Brooklyn, NY, 11235, US

(73) Assignee: NUTRISYSTEM FRESH, INC., Horsham, PA (US)

(21) Appl. No.: 12/248,035

(22) Filed: Oct. 8, 2008

Related U.S. Application Data
(60) Provisional application No. 60/978,267, filed on Oct. 8, 2007.

(51) Int. Cl. G06Q 50/00; G06Q 30/00

(52) U.S. Cl. 705/15

(57) ABSTRACT

The system and method of the present invention are directed to providing and managing periodic subscription-based victuals preparation and delivery services to customers thereof, while enabling the customers to selectively alter and/or manage pending victuals deliveries, without having to make permanent changes to their subscription plan, and without necessarily sacrificing or decreasing the health, nutrition, and weight-management benefits thereof. In one exemplary embodiment, the inventive system and method transmit notification of pending victuals deliveries to customers with sufficient notice to enable customers to selectively modify and/or cancel all or a portion thereof. The inventive system and method further include an automated credit system for handling full and/or partial meal cancellations.

### CROSS-REFERENCE TO RELATED APPLICATIONS

The present patent application claims priority from the commonly assigned U.S. Provisional Patent Application entitled “SYSTEM AND METHOD FOR ENABLING SELECTIVE CUSTOMER PARTICIPATION IN DYNAMICALLY CONFIGURING AND MANAGING AT LEAST A PORTION OF CUSTOMIZABLE INDIVIDUALIZED VICTUALS PROVISION SERVICES PROVIDED THERETO” (Ser. No. 60/978,267), filed on Oct. 8, 2007. The present patent application hereby further incorporates by reference herein, the entire subject matter of the commonly assigned co-pending U.S. Patent Application entitled “SYSTEM AND METHOD FOR PROVIDING AND MANAGING A CUSTOMIZABLE INDIVIDUALIZED VICTUALS PREPARATION AND DELIVERY SERVICE” (Ser. No. Not Yet Available), filed concurrently herewith, on Oct. 8, 2008.

### FIELD OF THE INVENTION

The present invention relates generally to a system and method for providing periodic subscription-based victuals preparation and delivery services to customers thereof, and more particularly to systems and methods for enabling enhanced customer selective participation in, and selective configuration and/or management of, periodic victuals provision services provided thereto.

### BACKGROUND OF THE INVENTION

For decades, “take-out” food—fully or near-fully prepared meals available through a restaurant or other food retailer—have been quite popular alternatives to home cooking. While for a very long time “take-out” food was most often viewed and consumed as an occasional treat, in recent years, for a number of reasons discussed further below, large segments of the population have begun to rely on such prepared meals, rather than on home cooking, as their primary source of sustenance. This trend has been particularly and increasingly prevalent among young couples and families where more and more often both spouses work, and who are frequently too exhausted to cook dinner, and also among professionals working long hours, and unwilling or unable to regularly cook for themselves. The trend has only grown in popularity as these same segments of the population have enjoyed a growth in disposable income, and have expressed the willingness to spend it purchasing prepared meals for themselves and their families.

In addition to “lack of time to cook” and “availability of greater disposable income”, a number of additional key factors further drive the demand for fresh, prepared meals that are an alternative to meals cooked in the home:
Lack of desire or energy to cook
Impracticality of cooking for a single person
Lack of skill to cook (the culinary skills of the vast majority of the younger segment of the population typically top out at the ability to boil water for pasta, making a sandwich, or on occasion, preparing eggs)
Lack of ability to cook (e.g., due to special dietary requirements, infirmities, etc.)
Better use of limited personal time in not having to clean up after meal preparation and consumption, especially considering that most purchased ready-to-eat meals are provided in disposable containers

While for a long time the vast majority of available “take-out” food was relegated to highly standardized products that emphasized convenience over other value attributes, consumers are also now demanding, in equal measure:
customized meals that include the specific foods and ingredients they wish to eat and exclude those they wish to avoid;
the meal quality one would expect of true home cooking or restaurant dining where the meals are prepared and served á la minute;
prepared meals that provide optimal nutrition (Relentless media attention on competing diet and nutrition programs, coupled with heightened awareness and concern about the epidemic of obesity and resulting health issues has promoted consumer interest in and commitment to greater overall wellness that incorporates, exercise, nutrition and other fundamental lifestyle choices. Choosing “ready-to-eat” meals that support the goal to “eat healthy” is part of this consumer behavior);
and still, convenience.
   Given these demand drivers many new entrants in prepared foods—from new curbside takeout options offered by traditional table service restaurants and new prepared meals sections in traditional grocery supermarkets—are entering the category. However many of these solutions only partially meet the full set of demand drivers for today's consumer.

First, while there are many grab-and-go options from the grocery and restaurant channels, the ability to customize these items is generally limited. Many products are cooked and packaged without consulting the consumer on how they would like their items prepared.

Second, the importance of customization becomes even more important in the context of providing optimal nutrition, because here consumers need options that carefully and consistently provide certain foods and not others while hitting certain nutritional benchmarks over time (number of calories, amount of fat, sodium, etc.). Moreover, while certain ready-to-eat healthy offerings are relatively readily available (such as packaged lunches), finding a variety of other types of healthy and tasty meals (such as breakfasts, dinners, and snacks) on a regular basis quickly becomes a daunting task, esp. for consumers outside of major metropolitan areas. The consumers are then in a “catch-22’: forced to return to their own meal preparation if they want to eat consistently meals that support optimal nutrition, but sacrificing the convenience of prepared meals which they also demand.

Third, the need for convenience is only somewhat met by providing prepared and pre-packaged items that the consumer then needs to pick-up. Many consumers are looking for an option to order once or occasionally and then have items delivered directly to them on an ongoing basis, thereby saving the time of physically having to go shop for items and on an ongoing basis, or re-order items that they know in advance they will need.

A number of attempts have been made to address the above-described challenges. In particular, one type of solution has proven extremely popular—a number of companies offer scheduled deliveries of several prepared meals one or more times a week, prepared and packaged in such a way that the customer can easily prepare the meal for consumption by heating it, or in certain cases, can eat it outright (e.g., if the meal is a salad).

Over time, the above offerings have evolved into full subscription-based meal preparation and delivery services, where after paying a per-day fee for a certain minimum period of time, a customer can receive a full set of daily meals (e.g., breakfast, lunch, dinner, and snacks),. Typically, customers can sign up for meal programs/packages of different quality and quantity levels that are accordingly priced. In most cases, higher priced meal programs offer a greater variation of provided meals over a period of time, with the lower priced offerings, repeating the same meals more frequently.

Companies offering meal preparation and delivery service packages have also taken advantage of the proliferation of inexpensive and readily available access to the Internet and have provided their customers with the ability to look at current and future menus and renew, cancel, or change their meal programs to higher or lower level. While a number of companies with such subscription-based meal programs have achieved a reasonable level of success, their offerings still suffer from a number of very serious drawbacks which prevent them from ever achieving a very high level of market penetration. Specifically, while they claim to have variety in meals over a predetermined period of time, most such companies only offer a single predetermined set of menu selections on any given day, or over a period of days, such that a customer who receives a delivery of meals for a three day period gets three different sets of meals and can decide which meals to eat which day. However, if the customer does not like certain foods or menu items, they are not given any choice except not to eat that meal. Also, in such cases, a customer cannot decide to cancel all meals for a particular day (if they are traveling), and cannot cancel specific meals (if for example they are going out to dinner).

In an attempt to address this problem, one subscription-based meal preparation and delivery company has offered a service where the customer can preview upcoming menus for a certain number of days forward, and, if they see a particular menu item they do not like, they can go through a process that involves selecting an alternate substitute meal from the entire pool of ALL different available meals items from that company (which exceeds a hundred different menu items) as a substitute. While this approach may appear to address the issues of inflexibility and lack of customer choice plaguing the competitive offerings, it suffers from several flaws, one being very serious.

First, while many customers who chose to utilize a subscription-based periodic meal preparation and delivery service are not happy about having predetermined planned menus with no choice of alternate meals, quite a few customers also would not be pleased to be forced to choose among over a hundred alternate menu items if there is a planned menu item they do not like. One of the goals of using such a subscription service is convenience, however with the above-described approach, the customer is forced to either regularly accept the planned menu items (which means giving up variety and flexibility) or to be faced with the daunting and time-consuming task of reviewing the company's entire pool of offerings and then selecting a substitute meal from the vast number of alternate choices.

This flaw becomes particularly frustrating for the customer if they want to change several menu items—they would have to repeatedly suffer through this process. To make matters even worse, the alternate menu choices are presented on the company's website as a scrollable “drop-down menu” where only the menu item names are listed. This means if the customer wants to get more information about an alternate item, he must select the item and activate web-page controls to view the item description, thereafter being required to take additional steps to go back to reviewing the full menu—an even more frustrating experience, which likely leads most customers to resign to accept the proffered menu choices rather than go through so much trouble to change them.

However, the greatest drawback of this company's menu-item substitution approach is that while the company expounds its carefully constructed menus that maximize health benefits and weight loss, they simultaneously allow a customer to completely disrupt the health benefits and other advantages derived from careful coordination of different menu items and quantities and types of ingredients and preparation techniques used therein, by selecting whatever meal items the customers feel like from the overall set of possible meal offerings. In essence, a customer willing to put the effort required in locating French toast from the menu pool item, can essentially elect to have three servings of it as three of their four meals, as opposed to having a well-balanced daily meal set.

In addition, all previously known prepared meal delivery services only offer subscription-based delivery of prepared menu-based meals. Customers wanting any other consumable items, e.g. beverages, fresh fruit, vegetables, etc. must either rely on having to shop in conventional supermarkets or place specific periodic orders for such items from supermarkets that offer online ordering and delivery.

Finally, while certain companies offer “family plans” for meal subscriptions, such offerings are limited to simple aggregation of separately available menus and simultaneous delivery of multiple meal sets. None offer any tools or techniques for controlling individual modification of subscribed meal plans by members of a subscribed household. Furthermore, none of the currently available meal provision subscription services enable subscriptions by third parties for the benefit of multiple other individuals or groups. For example, a corporation cannot obtain a meal subscription for the benefit of the employees in one or more of their offices.

It would thus be desirable to offer a system and method for providing and managing periodic subscription-based victuals preparation and delivery services to customers thereof, while enabling the customers to selectively alter and/or manage pending victuals deliveries without having to make permanent changes to their subscription plan and without necessarily sacrificing or decreasing the health, nutritional, and weight-management benefits thereof. It would also be desirable to offer a system and method for providing subscription-based victuals provision services, such as meal preparation and delivery services to customers thereof, where customers receive individualized notifications of pending victuals deliveries with sufficient notice to ensure that they have the opportunity to selectively make any modifications available thereto. It would further be desirable to provide a subscription-based meal preparation and delivery services system and method having the maximum flexibility in automatically handling both full and partial meal cancellations.

### BRIEF DESCRIPTION OF THE DRAWINGS

In the drawings, wherein like reference characters denote corresponding or similar elements throughout the various figures:

FIG. 1 is a schematic diagram of the infrastructure of one embodiment of an inventive periodic victuals provision (PVP) service system;

FIG. 2 is process flow diagram of an exemplary embodiment of a subscriber account set-up and plan configuration process that may be implemented in, and utilized in conjunction with, the PVP service system of FIG. 1;

FIG. 3 shows process flow diagrams for exemplary embodiments of a subscriber account set-up and plan configuration sub-processes of the subscriber account set-up and plan configuration process of FIG. 2 that may be implemented in, and utilized in conjunction with, the PVP service provider system of FIG. 1;

FIG. 4 is a schematic diagram of the data infrastructure and of various corresponding information elements stored therein, that may be included in a subscriber account administered by the PVP service provider system of FIG. 1;

FIGS. 5A-5B show a process flow diagram of an exemplary embodiment of an inventive prepared meals management process of PVP Plan Service Operations, that is performed at least in part by the PVP service provider system of FIG. 1;

FIG. 5C shows a process flow diagram of an exemplary embodiment of an inventive cancellation tracking and credit management process, of PVP Plan Service Operations, that is performed, at least in part by the PVP service provider system of FIG. 1, in response to any cancellations made by a subscriber during performance of the prepared meals management process of FIGS. 5A-5B, that is handled;

FIG. 6 is a schematic diagram of an exemplary subscriber graphical user interface (GUI) showing the informational and interactive GUI regions and controls that may be made available to subscribers to enable subscribers to access the PVP system of FIG. 1 and to view, configure, and manage various aspects of their account and their PVP subscription plan;

FIG. 7A is a schematic diagram of an exemplary embodiment of the interactive view region of the novel Subscriber GUI of FIG. 6, shown, by way of example, in a Monthly calendar view, that enables subscribers to at least view and manage their account information and their PVP subscription plan, by interacting therewith;

FIG. 7B is a schematic diagram of another exemplary embodiment of the interactive view region of the novel Subscriber GUI of FIG. 6, shown, by way of example, in a Weekly calendar view, that enables subscribers to at least view and manage their account information and their PVP subscription plan, by interacting therewith;

FIG. 8A show a schematic diagrams of an exemplary embodiment of a victuals information presentation structure that may be made available to the subscribers through the interactive view region of the novel Subscriber GUI of FIG. 6, and that also comprises a cancellation credit value assigned to each of the victuals items shown therein;

FIGS. 8B to 8D show schematic diagrams of exemplary embodiments of various victuals information presentation structures that may be made available to the subscribers through the interactive view region of the novel Subscriber GUI of FIG. 6;

FIG. 9 is a schematic diagram of an exemplary embodiment of the novel Subscriber GUI of FIG. 6, shown by way of example in a Day Control view in which the subscribers are able to manage their account and to make changes to pending victuals deliveries for a particular day; and

FIG. 10 is a process flow diagram of an Enhanced PVP Subscription Plan Management Process that automatically provides reminders of pending victuals deliveries to subscribers with sufficient notice to enable management thereof, and which may be implemented in, and utilized in conjunction with, the PVP service provider system of FIG. 1.

### SUMMARY OF THE INVENTION

The system and method of the present invention are directed to providing and managing periodic subscription-based victuals preparation and delivery services to customers thereof, while enabling the customers to selectively alter and/or manage pending victuals deliveries, without having to make permanent changes to their subscription plan, and without necessarily sacrificing or decreasing the health, nutrition, and weight-management benefits thereof. In one exemplary embodiment, the inventive system and method transmit notification of pending victuals deliveries to customers with sufficient notice to enable customers to selectively modify and/or cancel all or a portion thereof. The inventive system and method further include an automated credit system for handling full and/or partial meal cancellations.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The above-incorporated co-pending commonly assigned U.S. Patent Application entitled “SYSTEM AND METHOD FOR PROVIDING AND MANAGING A CUSTOMIZABLE INDIVIDUALIZED VICTUALS PREPARATION AND DELIVERY SERVICE”, (hereinafter referred to as “PA-1”), disclosed various advantageous embodiments of an inventive system and method that remedied the disadvantages of previously known subscription services for schedule-based delivery of prepared meals, by:
(1) providing customers with configurable periodic victuals provision (PVP) services subscription options, both with respect to the type of subscription plan purchased (e.g., relating to victuals types, quantities, frequency of deliverers, pending order change and cancellation options, etc.), as well as with respect to type of subscriber account (individual, group, and third party);
(2) generating/determining a pool of available menu selections that are individualized for each subscriber or subscriber group, for each delivery day of their corresponding subscription plan cycle;
(3) automatically selecting a default menu choice for each prepared meal category, based at least in part on each subscriber's expressed and/or inferred preferences (which may be readily determined from information provided by the subscriber, and/or from system-collected data relating to the subscriber's prior interactions with the inventive PVP system and method; and
(4) enabling customers of its PVP services, to selectively alter (e.g. from the default selections provided thereto) and/or manage pending planned victuals deliveries without sacrificing or decreasing the health, nutrition, and weight-management benefits thereof.

Furthermore, the PA-1 disclosed a novel inventive system and method for developing new victuals offerings, having an increased probability of favorable acceptance by the subscribers.

Building on certain novel features of PA-1, the system and method of the present invention provide subscription-based periodic victuals provision services with the following advantageous functionalities:
(1) enabling their subscribers (i.e., customers), to selectively participate in day-to-day management of their subscription plan without having to make permanent changes to their subscription plan account, such as for example changing or cancelling certain pending victuals deliveries for a particular day, without likewise changing the future planned victuals deliveries for that day the following week;
(2) providing advance of pending victuals deliveries with sufficient notice for subscribers to selectively make any allowed modifications thereto (e.g., cancelling one or more pending victuals deliveries for a particular day (including cancelling all pending deliveries for that day), and/or changing one or more pending deliveries to another available selection); and
(3) automatically and dynamically handling cancellation of full and/or partial deliveries on an ongoing basis.

Advantageously, the system and method of the present invention seamlessly work with, and complement, the novel system and method, and all embodiments thereof, disclosed in PA-1. However, it should also be understood that the system and method of the present invention, and the various embodiments thereof, may be readily adapted and configured to work with any other subscription-based periodic victuals provision service, to enable that service to provide its customers with one or more enhanced day-to-day subscription management opportunities, such as the selective ability to readily and easily modify pending victuals deliveries without having to permanently alter their subscription plan.

It should be noted that while the various exemplary embodiments of the inventive system and method are described with reference to “prepared meals”, and/or to “healthy meals”, it should be understood that the novel and advantageous inventive principles and techniques disclosed herein can be readily configured, adapted, and/or applied to subscription-based periodic provision of any victuals, such as “ready-to-cook” meals, groceries (fresh fruit, vegetables, etc.), bakery items, beverages, sundries, and the like, without departing from the spirit of the present invention.

Similarly, it should also be noted that while the various exemplary embodiments of the inventive system and method are described with reference to victuals deliveries that may take place on particular days of a week, and or that may have monthly or other periodic subscription cycles, it should be understood that the novel and advantageous inventive principles and techniques disclosed herein can be readily configured, adapted, and/or applied to subscription-based periodic victuals provision in accordance with any desired schedule, and over any desired period, without departing from the spirit of the present invention.

Additionally, while the above-incorporated PA-1 refers to various possible subscriber account types (individual subscribers, group subscribers, and 3^{rd} party subscribers), the various figures and accompanying descriptions of the present invention refer to exemplary periodic victuals provision service providers having individual subscriber accounts for the sake of simplicity only—it should be understood that the novel features of the present invention may be readily applied to periodic victual provision service subscriber accounts of any type (e.g., single, group, 3^{rd} party, etc.) without departing from the spirit of the invention.

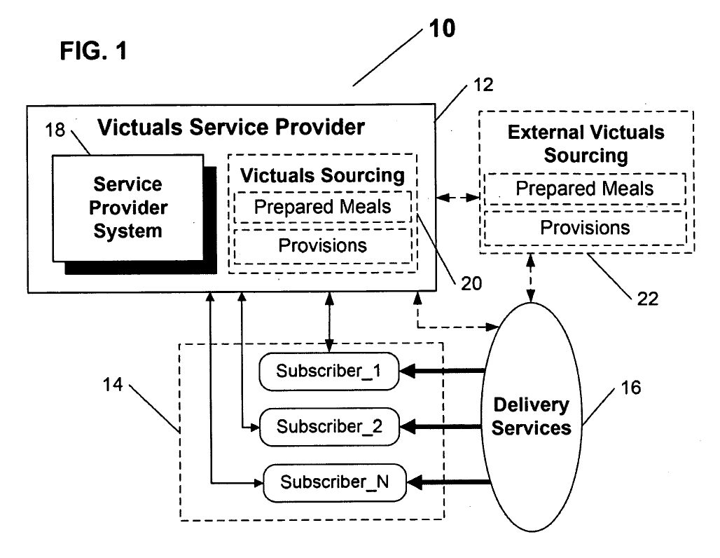

Referring now to FIG. 1, an exemplary embodiment of a subscription-based periodic victuals provision infrastructure, is shown as a PVP infrastructure 10. The PVP infrastructure 10 includes a victuals service (“VS”) provider 12 that provides a subscription-based service, delivering victuals (such as prepared meals) through delivery services 16 to subscribers 14. The VS provider 12 includes a service provider system 18 (such as the subscriber system 50 shown in FIG. 1B of PA-1), which governs operations of the VS provider 12, and which also includes internal victuals sourcing 20 (and/or external victuals sourcing 22—e.g., a third party contracted entity) for creating (e.g., cooking), and/or otherwise obtaining (e.g., purchasing from wholesalers) victuals for periodic delivery to the various subscribers 14. The delivery services 16 include the infrastructure for assembling, sorting and packaging victuals to be delivered, and then delivering the victuals to the appropriate subscribers via delivery vehicles within predetermined geographic areas.

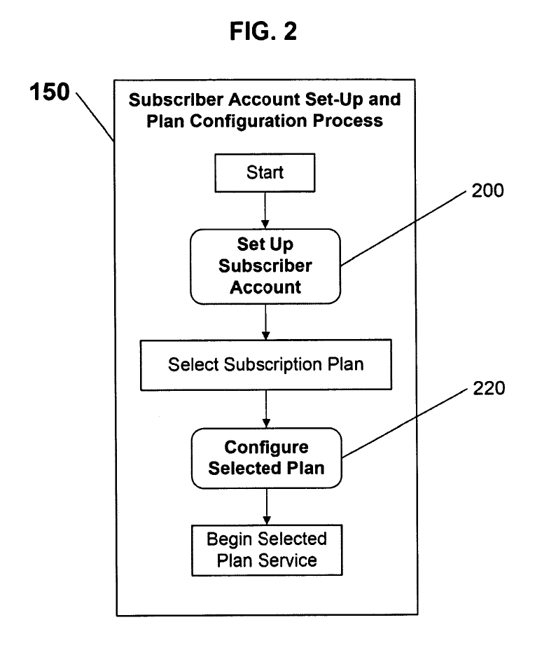

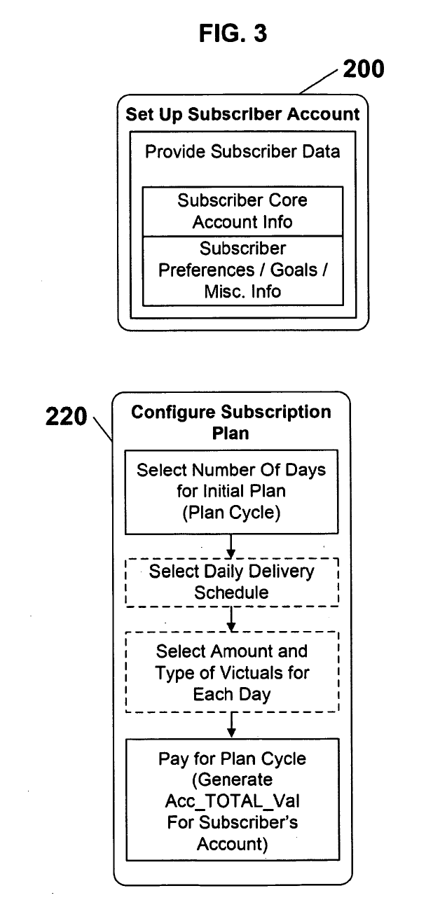

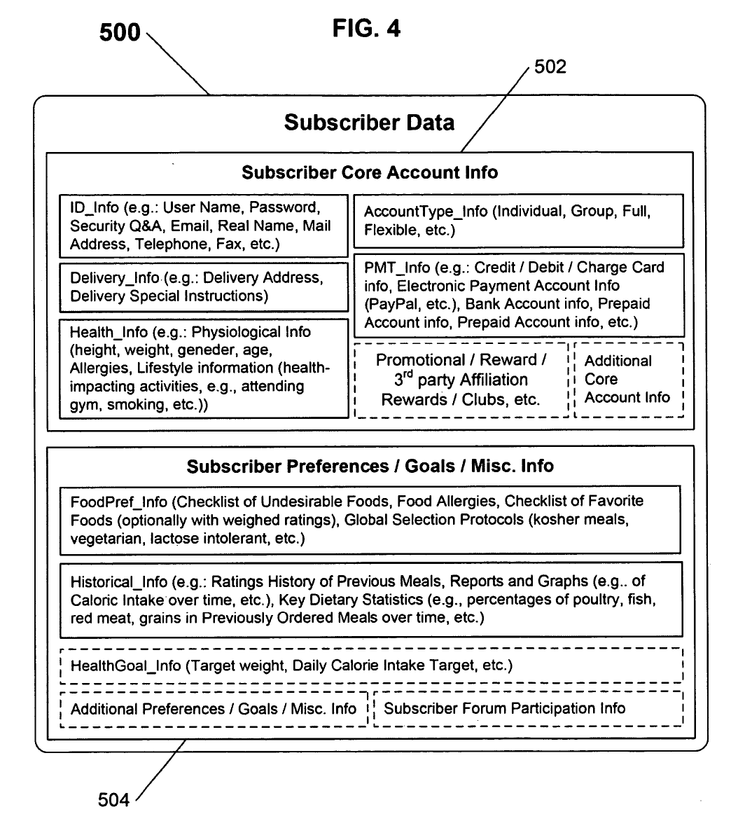

Referring now to FIGS. 2 to 4, exemplary embodiments of a Subscriber Account Set-Up and Plan Configuration Process 150 (FIG. 2), along with embodiments of sub-processes 200, 220 (FIG. 3), and Subscriber data structure 500 (FIG. 4) are shown. In the various FIGS. 2 to 4, drawing elements shown in dashed lines represent optional components and/or process steps. The process 150 is preferably performed by the service provider system 18 interacting with the subscriber 14, and enables a subscriber to set up their account, by providing requested information, as well to as select and configure a desired victuals provision plan.

Referring now to FIG. 2, during the process 150, the subscriber first participates in the corresponding account set up sub-process 200, of FIG. 3, during which the subscriber provides, to the service provider system 18, subscriber data 500 comprising subscriber core account information 502 and subscriber preferences/goals/misc. info 504 (see FIG. 4A). Thereafter, the subscriber then selects a desired PVP subscription plan—from one or more different plans. (While only two examples of subscription plans are shown—full and flexible—it should be understood that additional and/or alternate PVP subscription plans are contemplated by the present invention.)

By way of example only, the Table 1 below shows a comparison drawn between sample components of an exemplary full subscription plan and an exemplary flexible subscription plan.

TABLE 1
(Example):

| | | Flexible Subscription |
|---|---|---|
| | Full Subscription Plan | Plan |
| Unit of Purchase | Only one unit of | Individual meals by meal |
| | purchase is available: | type: customers any |
| | the daily meal bundle | number of breakfasts, |
| | that includes (1) | lunches, dinners, savory |
| | breakfast, lunch, | snacks and sweet snacks |
| | dinner, savory snack and | by meal type in whatever |
| | sweet snack | combination they like |
| Payment | Made in advance for the | Made when a pending |
| | entire order before any | order becomes active, |
| | deliveries | immediately prior to its |
| | | delivery |
| Order to Delivery | 1:many relationship - | 1:1 relationship - each |
| Relationship | there are multiple | delivery is its own order, |
| | deliveries made over the | paid for separately, and |
| | course of one order | non-cancellable or able |
| | | to be modified once the |
| | | order is processed |
| Units | 1:1 for deliveries made | No minimum or limit to |
| Purchased to | Monday through | the quantity of meals |
| Delivery | Thursday, and up to 3:1 | purchased for any |
| Relationship | for deliveries made | delivery |
| | Friday (to accommodate | |
| | customers who want to | |
| | have meals for the | |
| | weekend) | |
| Postponement | Yes | No. Orders are only |
| (cancellation) of a | | processed immediately |
| delivery within an | | before their delivery, |
| active order | | therefore there is no |
| | | need to support order |
| | | modifications and |
| | | cancellations once the |
| | | order is processed. |
| Subscription Length | Finite or open-ended, | Always open-ended. All |
| | depending on whether or | flexible subscriptions |
| | not the account is set to | will continue in an open |
| | “auto-renew” the order | ended fashion until the |
| | | subscription itself is |
| | | cancelled. |

The selected subscription plan is then configured at a sub-process 220. Reference should be made to the above-incorporated PA-1 which provides detailed descriptions of various plan subscription configurations.

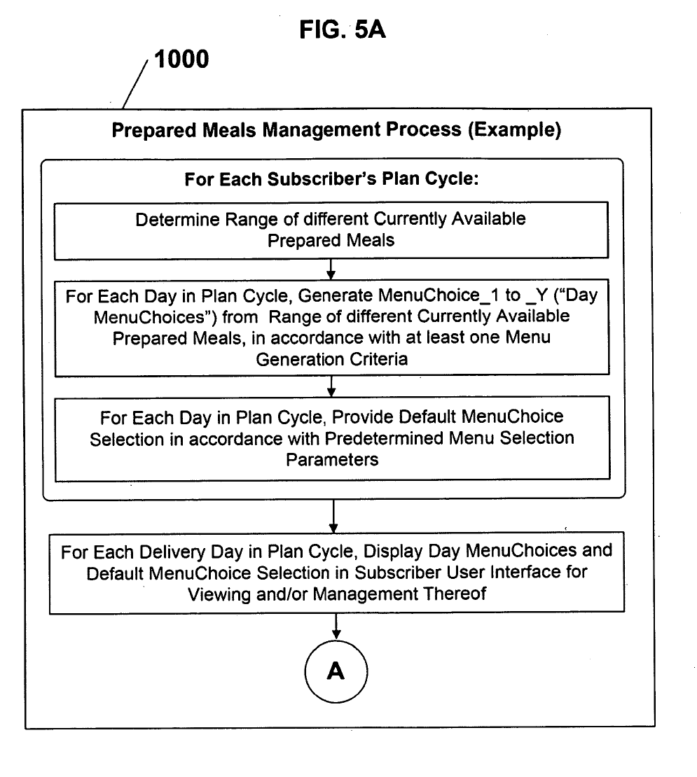

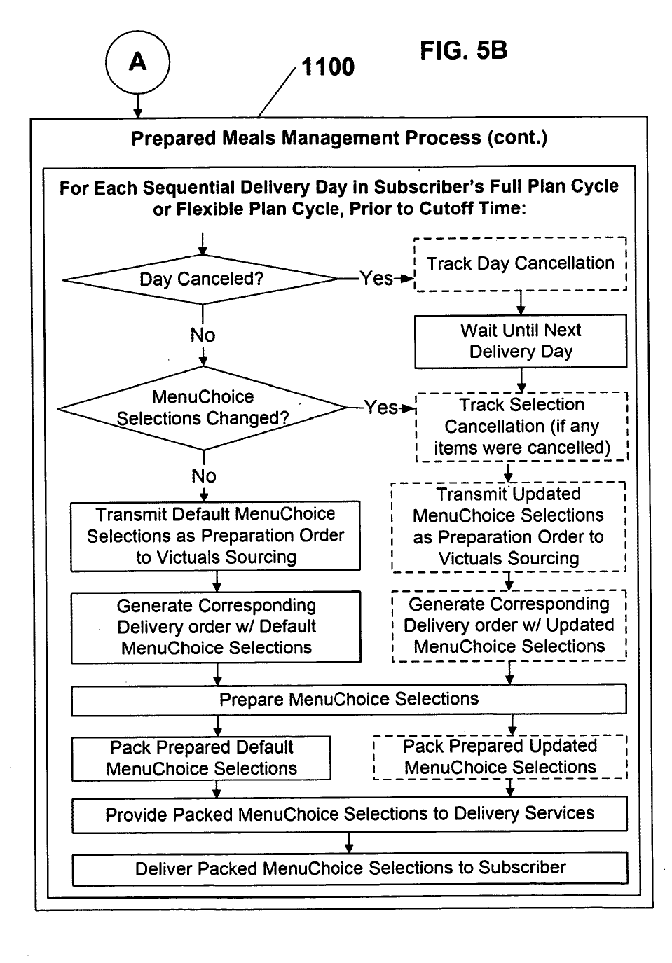

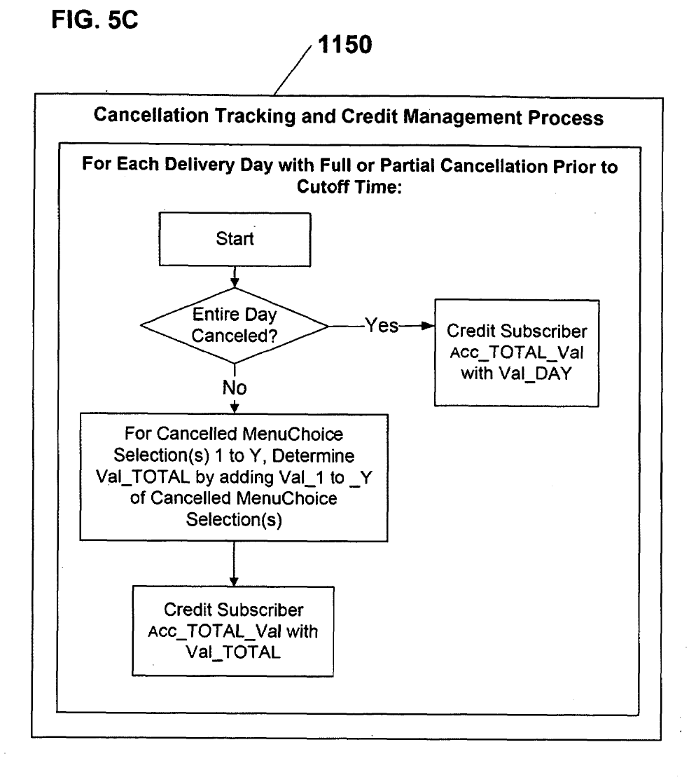

Referring now to FIGS. 5A-5B, an exemplary embodiment of a prepared meals management process 1100 is shown, which is shown and described in detail in FIGS. 6A-6B of the PA-1, and in the accompanying descriptions.

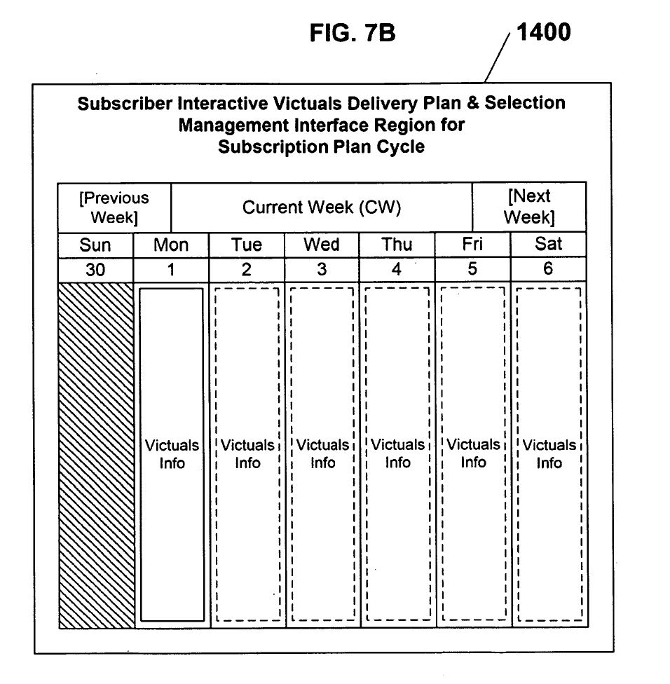

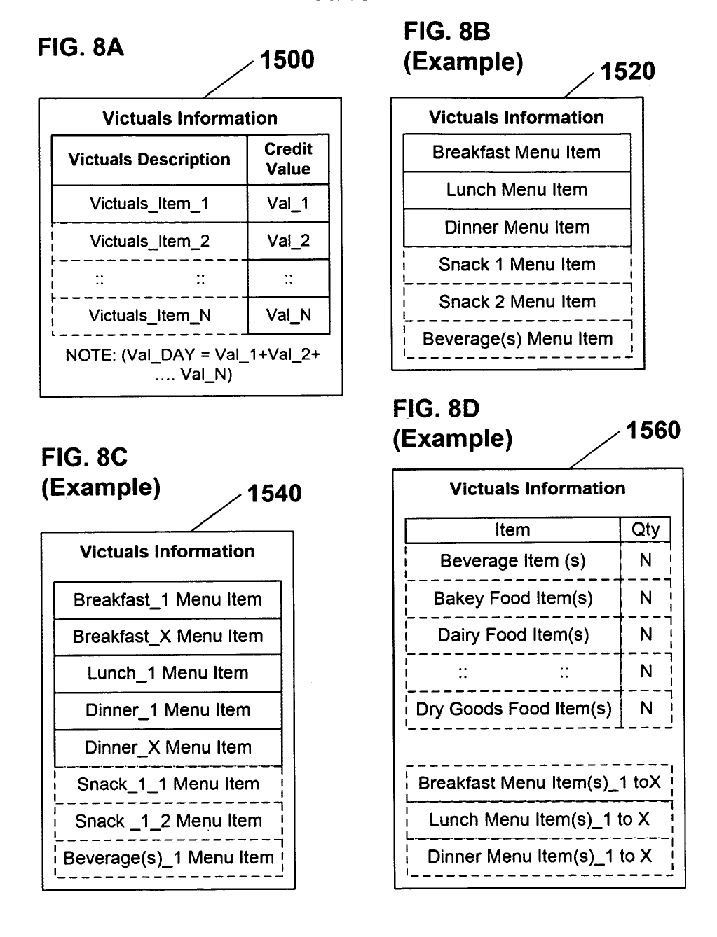

Referring now to FIG. 5C, an exemplary embodiment of a cancellation tracking and credit management process 1150, performed in conjunction with the prepared meals management process 1100 of FIGS. 5A-5B, is shown. In accordance with the present invention, preferably, each day in a subscription plan cycle, during which there are scheduled victuals deliveries, is assigned a cancellation value (Val_DAY), and each victuals item type available in that particular subscription plan (e.g., “Breakfast”, “Lunch”, “Dinner”, etc.) is likewise assigned an individual cancellation value (e.g., Val_1 to Val-N), such that the sum of the total values of individual victuals items is equal to the Val_DAY (see FIG. 8A). When a cancellation is made by a subscriber during the process 1100, the process 1150 is performed (substantially simultaneously, or at some point thereafter) to ensure that the subscriber's account is credited for either the full or partial cancellations. For example, if a day is cancelled, that day is then added to the subscriber's plan cycle. Preferably, when total values (Val_1 to Val-N) of all previously cancelled individual victuals items reaches Val_DAY, the subscriber is credited with an entire day, which is then added to the subscriber's plan cycle. Alternately, previously cancelled victuals items can be credited to the subscriber's plan on an individual basis.

Referring now to FIGS. 6 to 8D various embodiments of an exemplary subscriber graphical user interface (GUI) showing the informational and interactive GUI regions and controls that may be made available to subscribers, to enable subscribers to access the service provider system 18 of FIG. 1, and to view, configure, and manage various aspects of their account and their subscribed plan (e.g., full or flexible);

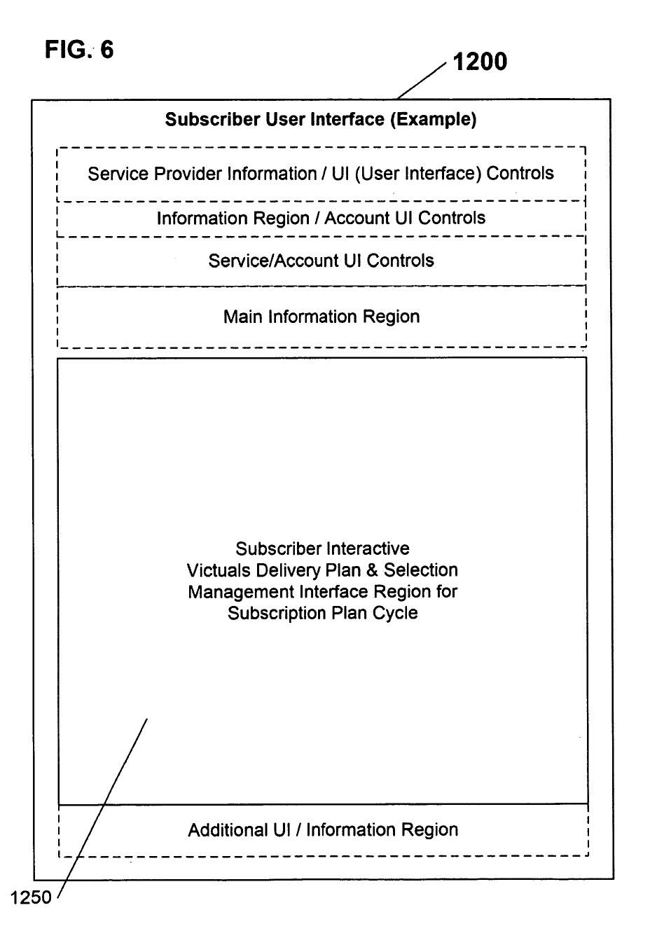

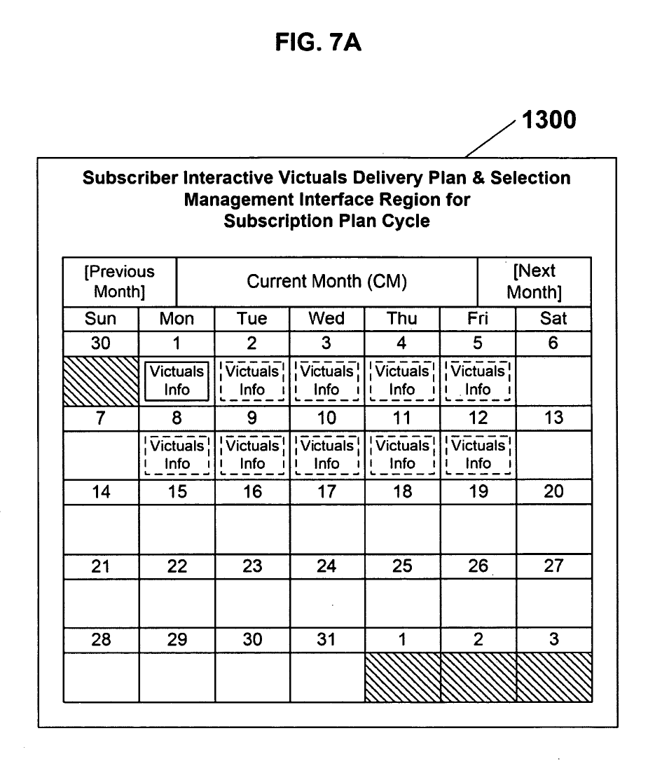

Referring to FIG. 6, the Subscriber GUI 1200 is shown, and while it has a number of optional regions for displaying information and/or for providing various controls, the key feature of the GUI 1200 is the region for Subscriber Interactive Victuals Delivery Plan & Selection Management (Interface region 1250), which allows the subscriber to readily and easily explore their plan options, and to make any desired modifications thereto. An exemplary “monthly view of a subscription plan cycle” is shown as an interface region 1300 in FIG. 7A. In the region 1300, by way of example, two weeks of a plan cycle going forward are shown (each “Victuals Info” element displaying at least a partial list of available menu selections), and may be browsed by the subscriber in various views, from monthly (region 1300, FIG. 7A) to weekly (region 1400, FIG. 7B)

Referring now to FIGS. 8A to 8D, various exemplary embodiments of different types and structures for presenting victuals information that may be made available to the subscribers through the interactive view region of the novel Subscriber GUI of FIG. 6. Victuals Information 1500 of FIG. 8A shows the various pending victuals deliveries for a particular day, along with cancellation values for each item. Victuals information 1520 to 1540 show different variations of victual items (“menu items” in FIGS. 8B and 8C), while FIG. 8D shows victual information 1560 in which the victuals to be delivered under the subscriber's plan are not prepared meals, but are in fact fruit, vegetables, and other food and drink-related items.

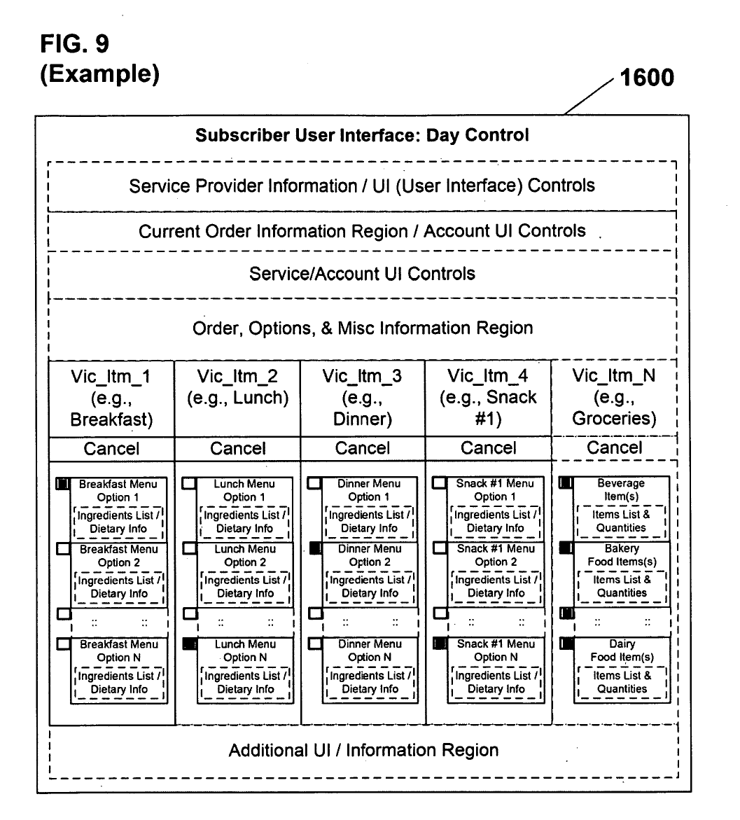

Referring now to FIG. 9, an exemplary embodiment of the novel Subscriber GUI of FIG. 6, shown by way of example as a Subscriber GUI 1600 in a Day Control view in which the subscribers are able to manage their account and their PVP subscription plan(s), for example by either accepting the menu options recommended by the service provider system (shown on GUI 1600 as filled boxes), or by making alternate choices.

Advantageously, through this novel functionality and easy-to-use interface, subscribers can easily and selectively make modifications to any particular “delivery day” of their subscription plan without having to make permanent changes in their subscriber accounts. Thus for example, if a subscriber plans to go out for dinner on the day shown in FIG. 9, he can readily cancel Vic_ltm_3 (Dinner), for that day, but still continue to receive dinners on the future corresponding days of the plan cycle (unless of course, the subscriber makes further changes). Similarly, if the subscriber does not like the pre-selected default Breakfast Menu Option 1, he can easily change it by simply checking off, the Breakfast Menu Option 2 (or any other option in that category). In one embodiment of the invention, in which all menu options are well-balanced and/or coordinated in accordance with a diet/nutrition plan, even by changing any or all menu selections from their pre-selected default values to any of their other options, the subscriber is still provided with a “healthy” meal.

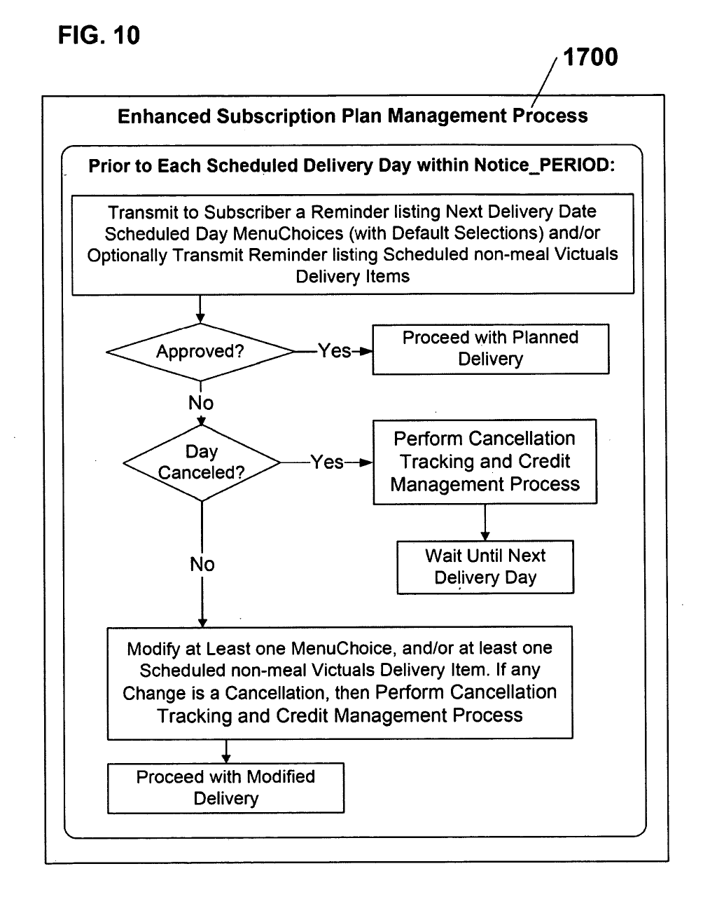

Finally, referring now to FIG. 10, an optional enhanced subscription plan management process 1700, that may be implemented in, and utilized in conjunction with, the PVP service provider system 18 of FIG. 1, is shown by way of example. The process 1700 enhances the subscribers' ability to easily make modifications to their plan on a day to day basis, by sending them periodic reminders of pending victuals deliveries with enough notice to enable a subscriber, should they wish to do so, to make changes (full or partial day cancellation, changing pending meal options, etc.) to the planned victuals deliveries for one or more upcoming days. These notifications may be short reminders of pending deliveries (for example via phone, email, and/or short message service (SMS) text messaging) reminding a subscriber to log into their account if they wanted to make changes. Alternately, the notifications may include features that enable subscribers to make desired changes (if any) by responding, without having to separately log into their account.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A method for subscription-based periodic victuals provision service operable to provide victuals to a plurality of subscribers in accordance with a subscription plan, and enabling enhanced selective day-to-day plan management by subscribers, comprising the steps of:
(a) enabling the subscribers, to selectively participate in day-to-day management of their subscription plan without having to make permanent changes to their subscription plan account;
(b) selectively providing advance of pending victuals deliveries with sufficient notice for subscribers to selectively make any allowed modifications thereto; and
(c) automatically and dynamically handling cancellation of full and/or partial deliveries on an ongoing basis.
